(19) United States
(12) Patent Application Publication
(10) Pub. No.: US 2026/0344623 A1
(43) Pub. Date: Nov. 5, 2026

(54) ACCESSORY FOR AN ANIMAL

(71) Applicant: CRYPTICA HOLDING BV, Rotterdam (NL)

(72) Inventors: Carlotta ATZERI, Rotterdam (NL); Esme Seher YILDIRAN, Rotterdam (NL)

(21) Appl. No.: 19/140,452

(22) PCT Filed: Dec. 20, 2022
(86) PCT No.: PCT/EP2022/087071

§ 371 Date: Jun. 18, 2025

(51) Int. Cl. A01K 27/00

(52) U.S. Cl. CPC A01K 27/003

(57) ABSTRACT

The present invention relates to an accessory, comprising at least one flexible structure (1), comprising an inner portion (2) surrounded at least in part by an outer portion (3), wherein the inner portion (2) is a cord (4), formed by twisting a plurality of wires and wherein each end of the cord (4) is folded back to form a loop (5) that is held in place by a swage sleeve (6), wherein the outer portion (3) is made of a decorative material, which has its ends fixed inside a fastening element, characterized in that the fastening element is a closed swage socket (8) with a coupling opening (9) and the decorative material of the outer portion (3) is a mesh or mesh-like structure (10).

### FIELD OF THE INVENTION

The present invention relates to an accessory, which may be used for holding pets and (domestic) animals and more specifically to a collar and a leash with handle.

### BACKGROUND

Dog collars and leashes designed to be used for walking and controlling large dogs must present certain characteristics such as resistance to pulling and a high degree of sturdiness. As a consequence, the leashes and collars for large dogs that are available in the art are made of rough materials and are often bulky, focusing on functionality rather than the aesthetic appearance of the object.

As many dog owners consider their pet part of the family, more attention is brought to the decorative aspect of dog accessories. As a consequence, a new market arises for luxury dog accessories, such as embellished leashes and collars. However, the currently available dog leashes and collars with jewelry-like aspects are designed for small dogs as dainty materials are not sufficiently sturdy for large dogs.

Covering a leash or collar made of sturdy material with a decorative layer would solve some of these issues.

A dog accessory is known from JPH10127199, which is disclosing a nylon-coated stainless steel wire, which is interpolated in the hollow inner part of a tube-shaped mesh (braid) and one end of the stainless steel wire is fixed to a mounting opening of a cable crimp (clamp) to which one end of the tube-shaped mesh is fixed. The wire is coated with nylon or polycarbonate or Teflon synthetic resin or the like.

Such an accessory according to the preamble is also known from JP4918195, which is a flexible structure, comprising an inner structure surrounded at least in part by an outer structure. The inner structure is a cord, formed by twisting a plurality of aligned steel wires. Each end of the cord is folded back to form a loop that is held in place by a cable crimp. The outer structure is a sheath, formed by a decorative material, which has its ends fixed into a fastening element.

These known dog collars and leashes are focused solely on the practical aspect, while compromising on the design.

The present invention aims to resolve at least some of the problems and disadvantages mentioned above thereof serve to provide a solution, which can be used for holding larger animals such as dogs as large as 250 kg or more, without compromising on the appearance.

### SUMMARY OF THE INVENTION

To this end, the present invention relates to an accessory, which includes a flexible structure, comprising an inner structure, surrounded at least in part by an outer structure according to claim 1. The inner structure is a cord, formed by twisting a plurality of aligned steel wires. Each end of the cord is folded back to form a loop that is held in place by a swage sleeve. The outer structure is a sheath, formed by a decorative material, which has its ends fixed inside a fastening element.

Preferred embodiments of the accessory are shown in any of claims 2 to 19. In particular, the invention relates to a collar, according to claims 17-19 and to a leash according to claims 10-16.

In a second aspect, the current invention relates to an assembly of a leash and collar according to claim 20. Preferred embodiments of the assembly are shown in claims 21-22.

### FIGURES

FIG. 1 shows a sectional view of an embodiment of the present invention.

FIG. 2 shows a detailed representation of a sectional perspective of an embodiment of the present invention.

FIG. 3 shows a perspective view of an embodiment of the present invention.

FIG. 4 shows a detailed representation of a sectional perspective of an embodiment of the present invention.

FIG. 5 shows a detailed representation of a sectional perspective of an embodiment of the present invention.

FIG. 6 presents in more detail a representation of a sectional perspective of an embodiment of the present invention.

FIG. 7 shows a schematic representation of an embodiment of the present invention.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Reference throughout this specification to “one embodiment” or “an embodiment” means that a particular feature, structure or characteristic described in connection with the embodiment is included in at least one embodiment of the present invention. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

The term “collar” as referred herein refers to an object placed around the neck of an animal. A collar may be used for restraint, identification, fashion, or protection. Identification tags and medical information may be placed on collars. Collars are often used in conjunction with a leash for restraining an animal, such as a dog.

The term “leash” refers to a long, thin and flexible object, such as a cord or cord-like material, used to secure, control or restrain an animal by attaching it to a collar, harness or halter. Leashes are variable in their length and the material they are made of, depending on their application.

A “leash handle” as used herein is the portion of the leash meant to be held by the user. Leash handles are often times manufactured from the same material as the rest of the leash, have good hand grip and often have a loop shape.

The term “pet” as used herein refers to any domestic or tamed animal kept for companionship or pleasure. Said pet may be understood as belonging to any animal species and is not limited to the widespread domestic animals used as pets. Said pet may be any mammal, reptile, amphibian, bird or fish. Non-limitative examples of pets are dogs, cats, horses, rabbits, pigeons, peacocks, chickens, pigs, parrots, lions, tigers, leopards, exotic felines, monkeys, apes, iguanas, lizards, geckos, rodents, and so on.

The terms “metal mesh” or “mesh” as used herein is understood as a flexible material preferably made of metal. The metal mesh is made of metal and/or alloy wires, metal and/or alloy sheets, metallic fibers, monofilaments, strands or yarns which are woven, welded, sintered or braided into a metal mesh or cloth.

A “mesh-like structure” is a decorative flexible structure made of metal links, like those used for watch bracelets, metal scales, chains or textiles containing metallic fibers.

In the first aspect, the invention relates to an accessory for an animal preferably a pet, comprising at least one flexible structure, comprising an inner portion surrounded at least in part by an outer portion, wherein the inner portion is a cord formed by twisting a plurality of wires and wherein each end of the cord is folded back to form a loop that is held in place by a swage sleeve. The outer portion of the flexible structure is made of a decorative material, which has its ends fixed inside a fastening element. The fastening element is a cover shell with a coupling opening and the decorative material of the outer portion is a mesh or mesh-like structure.

In a preferred embodiment of the accessory as disclosed herein, the decorative material of the outer portion is a metal mesh or metal mesh-like structure. However, it will be obvious to a person skilled in the art that any decorative layer suitable for covering flexible objects may be used with the accessory of the invention.

Alternatively, the decorative material of the outer portion of the accessory disclosed herein is made of any kind of plastic material such as polypropylene (PP), polyethylene terephthalate (PET), polyvinyl chloride (PVC), low-density polyethylene (LDPE or PE-LD), polystyrene (PS), or a resin such as epoxy resins, polyester resins, nylon and the like.

Materials suitable for making a metal mesh or mesh-like structure for an accessory according to the invention are aluminum, copper, brass, galvanized steel, nickel or nickel alloys, stainless steel, carbon steel, zamak, titanium or titanium alloys but are not limited to these. The metal mesh or mesh-like structure is preferably made of brass. Brass is an alloy of copper and zinc. The addition of zinc strengthens the copper in the alloy, and thus allows for a strong and durable decorative layer. Brass can be easier to work with than pure copper and allows for the manufacturing of fine meshes that have a jewelry-like aspect.

Alternatively, if the mesh or mesh-like structure is made of a material without aesthetic values, or a custom look is desired, the mesh or mesh-like structure may be coated, painted or galvanized with an attractive finish layer. In some embodiments of the accessory, the metal mesh or mesh-like structure is plated with a precious metal such as silver, gold or platinum. In other embodiments, the mesh or mesh-like structure is made of precious metals or alloys, such as platinum, titanium, silver or gold of 24k, 22k, 18k, 14 k or 10k.

In yet other embodiments, the metal mesh or mesh-like structure may be embellished with decorative or precious stones, pearls, rhinestones or artificial imitations thereof.

The inner portion of the accessory as disclosed herein is formed by twisting a plurality of wires, providing thus for a strong, sturdy and durable cord that may withstand the repeated pulling force of animals of 250 kg or heavier. The wires are preferably made of steel such as stainless steel or any other steel alloy known in the art. Non-limiting examples include piano wires and high-carbon content steel wires. Steel wires are stable in time, lightweight and are characterized by high tensile strength and high weather resistance. Kevlar or any other strong and flexible material may alternatively be used for the twisted wire of the inside portion of said accessory.

In a preferred embodiment, the end of the cord is folded to form a loop that is held in place by a swage sleeve. Any cable fixing means known in the art may alternatively be used to fix the loop such as hourglass sleeves, rope clips or the like. In some embodiments, the loop is fixed with more than one swage sleeve. In some embodiments, the swage sleeve is compressed around the base of the loop by applying force to said swage sleeve. The swage sleeve ensures that the loop remains fixed even when the pulling force of a large animal acts upon it. The swage sleeve may be made of any suitable material known in the art such as copper or aluminum.

In a further embodiment of the accessory as disclosed herein, the ends of the metal mesh or mesh-like structure are fixed to the cover shell and the cord is surrounded by the metal mesh or mesh-like structure. The metal mesh or mesh-like structure is thus fixed inside the cover shell by soldering, gluing or crimping, ensuring that said decorative layer does not peel off the cord. Fixing inside the cover shell ensures a neat design, as the edges of the mesh or mesh-like structure are not visible, but also prevents said edges to unravel, which is the case with some unbound woven meshes.

In a preferred embodiment of the accessory as disclosed herein, the cord is completely surrounded by the mesh or mesh-like structure.

Alternatively, the cord is partly covered by the mesh or mesh-like structure. This happens when the mesh or mesh-like structure has a relaxed structure with gaps, that allows the cord to be visible.

In a further preferred embodiment of the accessory of the invention as disclosed herein, the loop and the swage sleeve are positioned inside the cover shell. The loop is preferably positioned around the coupling opening of the cover shell. The cover shell and the positioning of the loop around the opening of the cover shell preserve the strength of the cord.

In an alternative embodiment, the swage sleeve is covered by the decorative layer of the outer portion. In such an embodiment, the swage sleeve is positioned lower than the cover shell and is thus covered by the mesh or mesh-like structure.

The cover shell is made of a material that is both strong and has an appealing finish. The cover shell is preferably made of stainless steel, carbon steel, brass, bronze or copper. The metal of the cover shell may be galvanized or plated. In some embodiments, the cover shell is plated with ruthenium, palladium, chrome, silver, gold, platinum or nickel. In other embodiments, the cover shell is made of a precious metal or alloy, such as platinum, titanium, silver or gold of 24k, 22k, 18k, 14 k or 10k.

In some embodiment of the accessory as disclosed herein, the coupling opening of the cover shell of at least one end of the flexible structure is fitted with a ring and/or a chain. Said ring or chain functions as an extension cord, a means of attachment for the connection means, or a means of obtaining a customizable accessory, for example fitting around the neck of various sizes of animals. The chain and ring may provide at the same time aesthetic function when it has a pleasing finish or is embellished.

In preferred embodiments of the accessory as disclosed herein, various members of the accessory are connected with a connection member. In a further preferred embodiment, the connection member is a snap hook. However, it will be obvious to a person skilled in the art that any suitable connection member may be used with the present invention. Non-limiting examples include trigger snaps, D-rings, O-rings, carabiners, quick links, delta links, or any rigging connectors or links. The connection member is made of a material that is both strong and has an appealing finish. The connection member is preferably made of stainless steel, carbon steel, brass, bronze or copper. The metal of the connection member may be galvanized or plated. In some embodiments, the connection member is plated with ruthenium, palladium, chrome, silver, gold, platinum or nickel. In other embodiments, the connection member is made of a precious metal or alloy, such as platinum, titanium, silver or gold of 24k, 22k, 18k, 14 k or 10k. The connection members of the accessory are made of high quality and durable materials that withstand the pulling force of large animals of over 250 kg, while maintaining at the same time an aesthetically pleasing appearance. At the same time, the connection member is easy to use so the animal owner can hook and unhook the leash to the collar as needed.

In some embodiments, the metal mesh, the cover shell and the connection member are made from the same material and/or have the same finish layer. Alternatively, the metal mesh, the cover shell and the connection member are made of different materials and/or have different finish layers.

In an embodiment, the accessory is a leash. In an embodiment, the leash comprises a handle and a cord member.

In an embodiment, the cord member and the handle are integrated and thus a single object. In such an embodiment the leash has a cover shell with a coupling opening. In some embodiments said coupling opening is positioned opposite to the handle. In another embodiment, said coupling opening is positioned at the handle.

In a preferred embodiment, the cord member of the leash comprises a flexible structure provided at each end with a cover shell having a coupling opening. The leash is formed by coupling the opening of the cover shell of one of the cord member's ends with the connection member of the handle.

In some embodiments, the cord member of the leash may comprise two or more flexible structures that are connected to each other at the level of the cover shells, with one or more connection members. This allows for the extension of the length of the cord member of said leash.

The handle of the leash is preferably formed by coupling the openings of the cover shells of both ends of a flexible structure with a connection member. Alternatively, the leash handle is formed by coupling rings and/or chains fitted to the coupling opening of the flexible structure with a connection member.

In another embodiment of the current invention, the accessory is a collar. The collar is preferably formed by coupling the openings of the cover shells of both ends of a flexible structure with a connection member. Alternatively, the collar is formed by coupling rings and/or chains fitted to the coupling opening of the flexible structure with a connection member. The coupling ring or chain fitted with the cover shells allow for a collar with an adaptable length that can fit around the neck of various animal sizes.

In a second aspect, the current invention relates to an assembly of a leash and collar wherein the leash and the collar are attached to each other by joining the cover shell of the free end of the cord member of the leash to the connection member of the collar. In a preferred embodiment, the leash and the collar are reversibly connected. This allows the pet owner to hook and unhook the leash freely.

It is preferred that the connection member of the assembly as disclosed herein is a snap hook as disclosed in any of the previous embodiments. However, it will be obvious to a person skilled in the art that any suitable connection member may be used with the present invention. Non-limiting examples include trigger snaps, D-rings, O-rings, carabiners, quick links, delta links, or any rigging connectors or links. The connection member is made of a material that is both strong and has an appealing finish as disclosed in any of the previous embodiments. The connection members of the assembly are made of high-quality and durable materials that withstand the pooling force of large animals of over 250 kg, while maintaining at the same time an aesthetically pleasing appearance. At the same time, the connection member is easy to use so the owner can hook and unhook the leash to the collar as needed.

It is preferred that the accessory or assembly disclosed in any of the previous embodiments is a dog accessory. The dog accessory or assembly is highly versatile and may be used with any dog breed weighing from 1 up to 250 kg or more. The current invention allows for the development of a modular accessory that is made of highly resistant materials and has a luxurious appearance. Some elements of the accessory are interchangeable, for example, the connection members. Other elements have similar manufacturing processes, for example, the flexible structures of the collar and of the cord member of the leash. The accessory of the invention is thus easy to manufacture and assemble. The hardware elements of the accessory, the cover shell, and the connection members are made of materials that endure high tension forces and are weather and scratch resistant and thus provide for a high-end product.

Further on, the present invention provides a sturdy and secure accessory while maintaining the aesthetic of a jewelry piece. The strength of the system is given by the inner structure embedded in the outer chain structure. The special design of the cord and the cover shell ensure the strength of the system and allow for the use of the collar and the leash with large and strong pets while the metal mesh or mesh-like structure and the cover shell are providing additional strength and are aesthetically pleasing. The accessory can withstand the pulling force of animals as large as 250 kg and more, while having an eye-catching and pleasant appearance.

The accessory as disclosed herein may be used for holding, walking or controlling animals, preferably dogs, of all sizes from 1 kg to 250 kg or more. It would be obvious that the current invention may be used for holding, walking and controlling any other animal, such as a dog, a cat, a pig, a horse, a tiger, a lion, exotic felines and the like.

It is obvious that the current invention is not limited to the embodiments described above and the shells and the methods described herein may be used for producing accessories that comprise alternative outer structures and embellishments.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

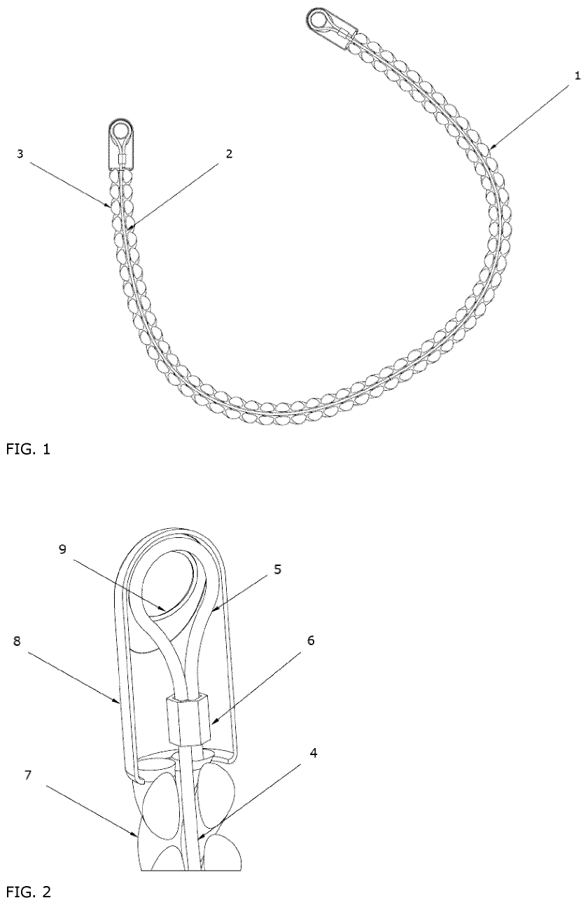

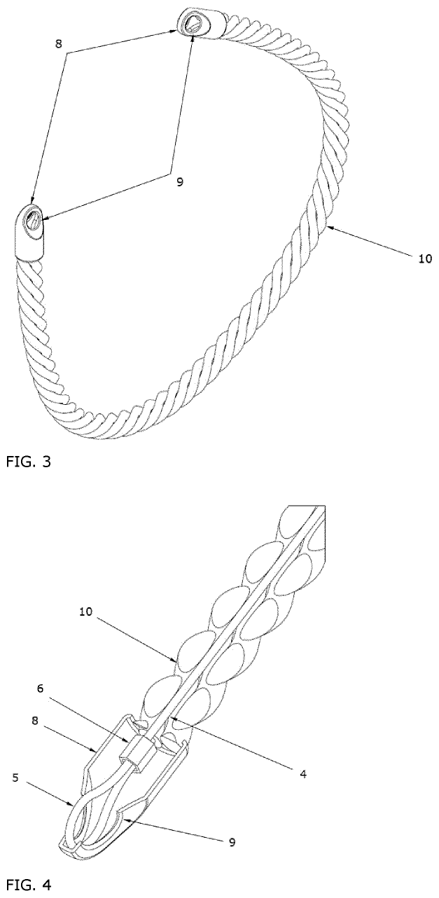

The figures show an accessory, including a flexible structure 1, comprising an inner structure 2, surrounded at least in part by an outer structure 3 (as shown on FIG. 1). The inner structure 2 is a cord 4, formed by twisting a plurality of aligned steel wires. Each end of the cord 4 is folded back to form a loop 5 that is held in place by a swage sleeve 6 (as shown FIG. 2). The outer structure 3 is a sheath 7, formed by a decorative material such as a mesh or mesh-like structure 10, preferably made of metal. The ends of the mesh or mesh-like structure 10 are fixed inside a fastening element, which is a cover shell 8 with a coupling opening 9 (as shown on FIG. 3). The mesh or mesh-like structure may be fixed by means of gluing or crimping, preferably by soldering. The cord 4 is surrounded by the sheath 7 formed by the mesh or mesh-like structure 10. The loop 5 and the swage sleeve 6 are placed inside the cover shell 8 on the end of the cord 4 (as shown on FIG. 4). Alternatively, the swage sleeve 6 may be placed lower, outside the cover shell 8 and covered by the decorative material (not shown). Along with it, the loop 5 is positioned around the coupling opening 9 of the cover shell 8 (as shown FIG. 2).

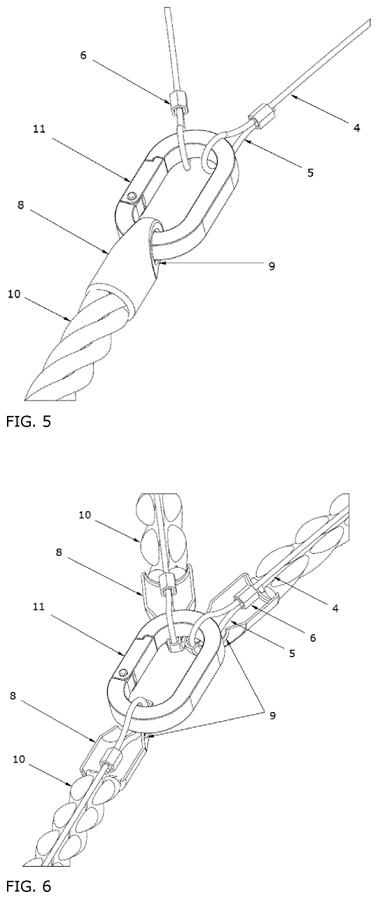

In a preferred embodiment (shown in FIGS. 5 and 6), the invention relates to a ring-shaped collar or handle for a leash, formed by coupling both ends of the flexible structure 1 with each other by a snap hook 10 fastened to each coupling opening 9 of the cover shell 8. In the embodiments of FIGS. 5 and 6, a snap hook 11 connects to three cover shells 8 and three loops 5 are attached. Two of the respective shells and loops belong to the collar and one to the leash.

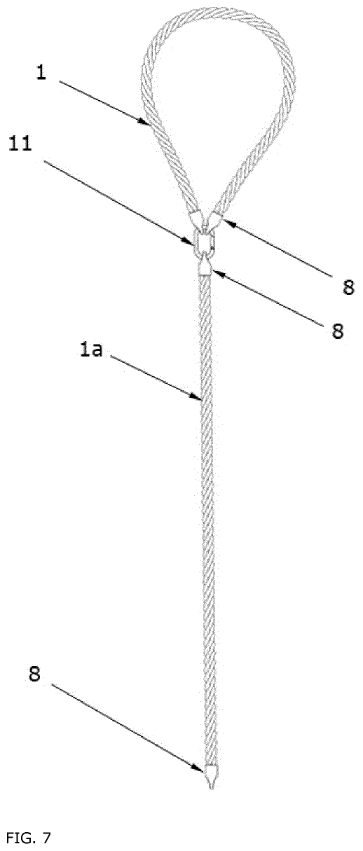

In another preferred embodiment (shown on FIG. 7), the invention relates to a leash, formed by joining at least one of the ends of additional flexible structure 1a by its coupling opening 9 of the cover shell 8 to the snap hook 11 of the collar and/or the handle.

In a particularly preferred embodiment, the mesh or mesh like-structure 10 is made from brass.

The following numbering refers to: (1) flexible structure; (2) inner structure; (3) outer structure; (4) cordage; (5) loop; (6) swage sleeve; (7) sheath; (8) cover shell; (9) coupling opening; (10) mesh or mesh-like structure; (11) snap hook.

1. An accessory for an animal comprising at least one flexible structure, comprising an inner portion surrounded at least in part by an outer portion, wherein the inner portion is a cord, formed by twisting a plurality of wires and wherein each end of the cord is folded back to form a loop that is held in place by a swage sleeve, wherein the outer portion is made of a decorative material, which has its ends fixed inside a fastening element, characterized in that the fastening element is a cover shell with a coupling opening and the decorative material of the outer portion is a mesh or a mesh-like structure.

2. The accessory according to claim 1, wherein the mesh or the mesh-like structure is made of metal.

3. The accessory according to claim 1, wherein ends of the mesh or the mesh-like structure are soldered to the cover shell and wherein the cord is surrounded by the mesh or mesh-like structure.

4. The accessory according to claim 1, wherein the loop and the swage sleeve are positioned inside the cover shell.

5. The accessory according to claim 1, wherein the swage sleeve is covered by the decorative material of the outer portion.

6. The accessory according to claim 1, wherein the loop is positioned around the coupling opening of the cover shell.

7. The accessory according to claim 2, wherein the mesh or the mesh-like structure is made of brass.

8. The accessory according to claim 1, wherein the twisted wires of the cord are made of steel.

9. The accessory according to claim 1, wherein the coupling opening of the cover shell of at least one end of the at least one flexible structure is fitted with a ring and/or a chain.

10. The accessory according to claim 1, wherein the accessory is a leash.

11. The accessory according to claim 10, wherein the leash comprises a handle and a cord member.

12. The accessory according to claim 11, wherein the cord member and the handle of the leash are integrated and have a cover shell with a coupling opening.

13. The accessory according to claim 11, wherein the cord member of the leash comprises a flexible structure provided at each end with a cover shell having a coupling opening.

14. The accessory according to claim 13, wherein the handle is formed by coupling the openings of the cover shells of both ends of a flexible structure with a connection member.

15. The accessory according to claim 13, wherein the handle is formed by coupling rings and/or chains fitted to the coupling opening of the flexible structure with a connection member.

16. The accessory according to claim 15, wherein the leash is formed by coupling the opening of the cover shell of one of the cord member's ends with the connection member of the handle.

17. The accessory according to claim 1, wherein the accessory is a collar.

18. The accessory according to claim 17, wherein the collar is formed by coupling the openings of the cover shells of both ends of a flexible structure with a connection member.

19. The accessory according to claim 17, wherein the collar is formed by coupling rings and/or chains fitted to the coupling opening of the flexible structure with a connection member.

20. (canceled)

21. The accessory according to claim 18, wherein the connection member is a snap hook.

22. (canceled)
